(19) United States
(12) Patent Application Publication
(10) Pub. No.: US 2022/0356121 A1
(43) Pub. Date: Nov. 10, 2022

(54) ZIRCONIA CERAMIC, METHOD FOR PREPARING ZIRCONIA CERAMIC, USE THEREOF, AND COMPOSITION INCLUDING THE SAME

(71) Applicant: BYD COMPANY LIMITED, Shenzhen (CN)

(72) Inventors: Ge CHEN, Shenzhen (CN); Xinping LIN, Shenzhen (CN); Wei TANG, Shenzhen (CN)

(21) Appl. No.: 17/641,937

(22) PCT Filed: Sep. 10, 2020
(86) PCT No.: PCT/CN2020/114398

§ 371 Date: Mar. 10, 2022

(30) Foreign Application Priority Data
Sep. 10, 2019 (CN) 201910851118.8

(51) Int. Cl. C04B 35/48; C04B 35/626; C04B 35/634

(52) U.S. Cl. CPC C04B 35/481; C04B 35/6264; C04B 35/63416; C04B 35/63488; C04B 2235/3217; C04B 2235/3244; C04B 2235/662

(57) ABSTRACT

A zirconia ceramic includes the following elements: 60.5-70.5 wt % of Zr, 2.5-5.45 wt % of Y, 0.05-2.65 wt % of Al, 0.015-1.07 wt % of Si, and 0.34-2.8 wt % of M. M includes at least one of Nb or Ta. The zirconia ceramic has a phase composition which includes tetragonal zirconia, alumina and zirconium silicate. The total content of alumina and zirconium silicate is 0.2-12 wt %, and the content of the tetragonal zirconia is 84-99.3 wt %. The tetragonal zirconia includes a solid solution of zirconia formed with yttrium oxide and MₓO_{y}, x satisfies 1≤x≤3, and y satisfies 3≤y≤6.

### FIELD

The present disclosure relates to the field of zirconia ceramics, and in particular, to a zirconia ceramic, a method for preparing a zirconia ceramic, use thereof, and a composition including the same.

### BACKGROUND

Zirconia ceramics have the characteristics of good corrosion resistance, high hardness, high strength, and high toughness (e.g., up to 5-6 Pa m^{1/2}), but may still have the defect of weak impact resistance, when made into a large-area appearance component. In addition, they may also have heavy weight caused by high density and signal transmission problem caused by high dielectric constant when fabricated into a back cover product for electronic devices such as mobile phones. In view of these problems, although the density and dielectric constant can be reduced by adding more alumina, the high hardness and high brittleness of alumina may greatly increase the processing difficulty, resulting in a low yield, and high cost. Therefore, the development of a ceramic with high impact resistance and toughness is critical to the use of ceramic back covers in the 5G era.

### SUMMARY

In view of the problem that existing zirconia ceramics cannot have both impact resistance and toughness, an object of the disclosure is to provide a zirconia ceramic, a method for preparing a zirconia ceramic, use thereof, and a composition including the same.

To achieve the above object, a first aspect of the disclosure provides a zirconia ceramic, the zirconia ceramic including the following elements: 60.5-70.5 wt % of Zr, 2.5-5.45 wt % of Y, 0.05-2.65 wt % of Al, 0.015-1.07 wt % of Si, and 0.34-2.8 wt % of M, where M includes at least one of Nb or Ta; and the zirconia ceramic having a phase composition including: tetragonal zirconia, alumina and zirconium silicate, where the total content of alumina and zirconium silicate is 0.2-12 wt %, and the content of the tetragonal zirconia is 84-99.3 wt %; and the tetragonal zirconia includes a solid solution of zirconia formed with yttrium oxide and MₓO_{y}, where x satisfies 1≤x≤3, and y satisfies 3≤y≤6.

A second aspect of the disclosure provides a zirconia ceramic having a phase composition including: tetragonal zirconia, alumina and zirconium silicate, where the total content of alumina and zirconium silicate is 0.2-12 wt %, and the content of the tetragonal zirconia is 84-99.3 wt %; the tetragonal zirconia includes a solid solution of zirconia formed with yttrium oxide and MₓO_{y}, and the zirconia ceramic includes Yin a content of 2.5-5.45 wt %, and M in a content of 0.34-2.8 wt %; and M includes at least one of Nb or Ta, x satisfies 1≤x≤3, and y satisfies 3≤y≤6.

A third aspect of the disclosure provides a composition, including: a zirconia-containing component, alumina, zirconium silicate, and MₓO_{y}, where based on the total amount of the zirconia-containing component, the zirconia-containing component includes zirconia and 2-4 mol % of yttrium oxide; and based on the total weight of the composition, the content of the zirconia-containing component is 84-99.3 wt %, the total content of alumina and zirconium silicate is 0.2-12 wt %, and the content of MₓO_{y} is 0.5-4 wt %.

A fourth aspect of the disclosure provides a method for preparing a zirconia ceramic, including: (1) forming a slurry from powders of components in a composition of the disclosure; (2) drying the slurry, to obtain a composite zirconia powder; and (3) forming and sintering the composite zirconia powder, to obtain a zirconia ceramic.

A fifth aspect of the disclosure provides use of a zirconia ceramic according to the disclosure in the preparation of electronic product casings or ornaments.

The disclosure provides a zirconia ceramic, which includes: 60.5-70.5 wt % of Zr, 2.5-5.45 wt % of Y, 0.05-2.65 wt % of Al, 0.015-1.07 wt % of Si, and 0.34-2.8 wt % of Nb and/or Ta. The zirconia ceramic has a phase composition including: 84-99.3 wt % of tetragonal zirconia, and 0.2-12 wt % of alumina and zirconium silicate; where the tetragonal zirconia is a solid solution of zirconia formed with yttrium oxide, niobium oxide and/or tantalum oxide.

In some embodiments, the weight ratio of alumina and zirconium silicate is (1:1)-(1:5).

The disclosure provides a composition for preparing a zirconia ceramic of the disclosure, which includes a zirconia powder, an alumina powder, a zirconium silicate powder, and a niobium oxide and/or tantalum oxide powder, where based on the total amount of the zirconia powder, the zirconia powder includes 2-4 mol % of yttrium oxide; and based on the total weight of the composition, the content of the zirconia powder is 84-99.3 wt %, the total content of the alumina powder and the zirconium silicate powder is 0.2-12 wt %, and the content of the niobium oxide and/or tantalum oxide power is 0.5-4 wt %.

In some embodiments, in the composition, the weight ratio of alumina to zirconium silicate is (1:1)-(1:5).

The disclosure provides a method for preparing a zirconia ceramic, including: (1) adding water to various powders in the composition of the disclosure, and wet milling, to obtain a slurry; (2) drying the slurry, to obtain a composite zirconia powder; and (3) forming the composite zirconia powder, and sintering in air, to obtain a ceramic. By means of the above technical solutions, the disclosure provides a zirconia ceramic with excellent impact resistance and also high toughness.

### BRIEF DESCRIPTION OF THE DRAWINGS

FIG. 1 is an SEM image of a ceramic produced in Example 1 of the disclosure; and

FIG. 2 is an SEM image of a ceramic produced in Comparative Example 2 of the disclosure.

### DETAILED DESCRIPTION

Endpoints of all ranges and all values disclosed herein are not limited to the precise ranges or values, and these ranges or values should be understood as including values close to these ranges or values. For value ranges, endpoint values of the ranges, the endpoint values of the ranges and separate point values, and the separate point values can be combined with each other to obtain one or more new value ranges. These value ranges should be construed as being specifically disclosed in the present specification.

A first aspect of the disclosure provides a zirconia ceramic, the zirconia ceramic including the following elements: 60.5-70.5 wt % of Zr, 2.5-5.45 wt % of Y, 0.05-2.65 wt % of Al, 0.015-1.07 wt % of Si, and 0.34-2.8 wt % of M, where M includes at least one of Nb or Ta; and the zirconia ceramic having a phase composition including: tetragonal zirconia, alumina and zirconium silicate, where the total content of alumina and zirconium silicate is 0.2-12 wt %, and the content of the tetragonal zirconia is 84-99.3 wt %; and the tetragonal zirconia includes a solid solution of zirconia formed with yttrium oxide and MₓO_{y}, where x satisfies 1≤x≤3, and y satisfies 3≤y≤6.

According to an embodiment of the disclosure, the zirconia ceramic has a phase composition including: tetragonal zirconia, alumina and zirconium silicate, where the total content of alumina and zirconium silicate is 0.2-12 wt %, and the content of the tetragonal zirconia is 84-99.3 wt %; the tetragonal zirconia includes a solid solution of zirconia formed with yttrium oxide and MₓO_{y}, and the zirconia ceramic includes Yin a content of 2.5-5.45 wt %, and M in a content of 0.34-2.8 wt %; and M includes at least one of Nb or Ta, x satisfies 1≤x≤3, and y satisfies 3≤y≤6.

The zirconia ceramic includes: 60.5-70.5 wt % of Zr, 2.5-5.45 wt % of Y, 0.05-2.65 wt % of Al, 0.015-1.07 wt % of Si, and 0.34-2.8 wt % of M. According to an embodiment of the disclosure, the zirconia ceramic further includes an appropriate amount of O. Those skilled in the art can understand that the zirconia ceramic will necessarily include element O, where the content of element O depends on the content of elements Zr, Y, Al, Si and M, to form, without limitation, zirconia, yttrium oxide, zirconium silicate, alumina, and MₓO_{y}.

Those skilled in the art can determine x and y according to the valence of M. For example, x can be 2, y can be 5, and MₓO_{y} may include at least one of Nb₂O₅ or Ta₂O₅. The ceramic has high density, high toughness and high impact resistance, and can be white.

According to an embodiment of the disclosure, the zirconia ceramic includes: 63-68.75 wt % of Zr, 3.35-4.7 wt % of Y, 0.53-1.58 wt % of Al, 0.15-0.92 wt % of Si, and 0.68-2.1 wt % of M. In other words, the zirconia ceramic includes 0.68-2.1 wt % of Nb and/or Ta, that is, the zirconia ceramic includes at least one of Nb or Ta, and the content of at least one of Nb or Ta is 0.68-2.1 wt %. According to an embodiment of the disclosure, the zirconia ceramic further includes an appropriate amount of O. According to an embodiment of the disclosure, the weight ratio of alumina to zirconium silicate is 1: (1-5). In some embodiments, the weight ratio of alumina to zirconium silicate may be 1: (1-2.25). Further, the content relationship between Al and Si is defined in the zirconia ceramic, to improve the performance of the ceramic, and make it have both high impact resistance and toughness. In some embodiments, the weight ratio of Al:Si is (2:3)-(5:1). In some embodiments, the weight ratio of Al:Si may be (1.6:1)-(3.5:1). The weight ratio can be selected from (1.6:1), (1.8:1), (2.0:1), (2.2:1), (2.4:1), (2.6:1), (2.8:1), (3.0:1), (3.2:1), (3.4:1), (3.5:1), and a range defined by any of the above values.

According to an embodiment of the disclosure, the element content can be detected by high-energy XRF. the elemental composition of the zirconia ceramic may also include other elements, such as oxygen.

The phases contained in the zirconia ceramic provided in the disclosure can be determined by XRD. In some embodiments, the zirconia ceramic has a phase composition including: tetragonal zirconia, alumina and zirconium silicate, where the total content of alumina and zirconium silicate is 2-9 wt %, and the content of the tetragonal zirconia is 88-97 wt %. In the XRD spectrum, a diffraction peak of zirconia of a tetragonal phase appears, which is a solid solution of zirconia formed with yttrium oxide, niobium oxide and/or tantalum oxide, added in the zirconia ceramic. The solid solution can be a solid solution of zirconia formed with yttrium oxide and niobium oxide, a solid solution of zirconia formed with yttrium oxide and tantalum oxide, or a solid solution of zirconia formed with yttrium oxide, niobium oxide, and tantalum oxide. The zirconia ceramic may also include other phases, provided that they have no negative effect on the zirconia ceramic of the disclosure. In the disclosure, the contents of the phases contained in the zirconia ceramic are based on the zirconia ceramic.

The zirconia ceramic of the disclosure has high impact resistance and toughness. In some embodiments, the toughness of the zirconia ceramic is 10.0 MPa m^{1/2} or higher. For example, the toughness of zirconia ceramic may be 10.9-13 MPa m^{1/2}.

According to an embodiment of the disclosure, the Vickers hardness of the zirconia ceramic is 1170-1280 Hv.

According to an embodiment of the disclosure, in the drop weight impact test of the zirconia ceramic, the average drop height is 27.5 cm or higher. For example, the average drop height may be 30.5-37 cm.

According to an embodiment of the disclosure, the deformation rate of the zirconia ceramic is 0%. That is, in the detected samples, The defect rate is low.

According to an embodiment of the disclosure, the zirconia ceramic can also possess other improved mechanical performances.

A second aspect of the disclosure provides a composition, including: a zirconia-containing component, alumina, zirconium silicate, and MₓO_{y}.

Based on the total amount of the zirconia-containing component, the zirconia containing component includes zirconia and 2-4 mol % of yttrium oxide. based on the total weight the composition, the content of the zirconia-containing component is 84-99.3 wt %, the total content of alumina and zirconium silicate is 0.2-12 wt %, and the content of MₓO_{y} is 0.5-4 wt %.

According to some embodiments of the disclosure, each component in the composition can exist in the form of a powder.

According to an embodiment of the disclosure, the provided composition includes various oxides, with which a zirconia ceramic, having high toughness, high impact resistance, and white color can be obtained. In some embodiments, in the composition, the amounts of various oxides may further meet the following conditions: based on the total amount of the composition, the content of the zirconia-containing component is 88-97 wt %, the total content of alumina and zirconium silicate is 2-9 wt %, and the content of MₓO_{y} is 1-3 wt %. In some embodiments, the total amount of various oxides in the composition is 100 wt %.

In the disclosure, yttrium oxide, niobium oxide and/or tantalum oxide have a stabilizing and toughening effect, alumina has a strengthening effect, and zirconium silicate can aggregate with alumina to produce heterogeneous particles (aggregate state of zirconium silicate and alumina), to increases the toughness and impact resistance of the composition. When the zirconia ceramic provided in the disclosure particularly includes the above-mentioned specific contents of various elements and phases, a zirconia ceramic with improved toughness and impact resistance can be obtained synergistically. When the contents of various oxides go beyond the above limits, no zirconia ceramic that satisfies the mechanical performances of the disclosure can be provided. Moreover, the zirconia ceramic meeting the above requirements can also have a white color.

According to an embodiment of the disclosure, in some embodiments, in the composition, the weight ratio of alumina to zirconium silicate is 1:(1-5). By directly adding the zirconium silicate and alumina components in the composition, alumina and zirconium silicate are combined and interact at a specific ratio. The aggregate state formed in the zirconia ceramic imparts improved impact resistance to the zirconia ceramic, so the ceramic has good deformation resistance and high drop weight performance. In some embodiments, the weight ratio of alumina to zirconium silicate is (1:1)-(1:2.25), and can be selected from (1:1.1), (1:1.2), (1:1.3), (1:1.4), (1:1.5), (1:1.6), (1:1.7), (1:1.8), (1:1.9), (1:2.0), (1:2.1), (1:2.2) and (1:2.25), and a range defined by any of the above values.

According to an embodiment of the disclosure, the composition is a composition for preparing the above-mentioned zirconia ceramic.

A third aspect of the disclosure provides a method for preparing a zirconia ceramic, including: (1) forming a slurry from powders of components in a composition of the disclosure; (2) drying the slurry, to obtain a composite zirconia powder; and (3) forming and sintering the composite zirconia powder, to obtain a ceramic.

According to an embodiment of the disclosure, in the step (1), the forming includes: mixing the powders of components in the composition, a dispersant and a binder, to obtain the slurry.

In the disclosure, the particle size of the powder of each component in the composition is not limited. A powder with a smaller particle size can be used as a raw material, and various powders in the composition, a dispersant and a binder are mixed, to obtain the slurry. A powder with a larger particle size can also be used as a raw material, and various powders in the composition, a dispersant and a binder are wet milled, to reduce the particle size of the powder by wet milling, in this way, the slurry is obtained. This is beneficial to reducing the cost of preparing zirconia ceramics.

Hereinafter, description is given with a powder with a larger particle size as a raw material. For example, the powder including the zirconia component contains yttrium oxide, has a median particle size of 0.3-0.6 μm, and a specific surface area of 7-13 m²/g. The median particle size of the MₓO_{y} powder is 8-12 μm. When MₓO_{y} is niobium oxide, the median particle size of the niobium oxide powder is 8-12 μm. When MₓO_{y} is tantalum oxide, the median particle size of the tantalum oxide powder is 8-12 μm. The median particle size of the zirconium silicate powder is 0.5-1 μm. The median particle size of the alumina powder is 0.15-0.6 μm.

In the step (1), various oxide powders as raw materials are milled, to reduce the particle size and obtain a slurry. The milling process is wet milling, and the specific process includes: mixing various oxide powders and water to form a slurry, mixing by ball milling, and pulverizing by sand milling, to allow the median particle sizes of various oxide powders to reach nanoscale (for example, 250-500 nm). More specifically, the various oxide powders are ball-milled with water in a ball mill jar for 8-10 hrs according to the contents described in the disclosure, and then sand milled with a dispersant and water in a sand mill for 8-10 hrs, and finally, a binder (such as PVA and/or polyethylene glycol 4000) is added at a suitable ratio and stirred for 2-4 hrs. In the ball mill jar and sand mill, a zirconia ceramic liner and zirconia grinding balls are used. The particle sizes of zirconia grinding balls, the ratio of grinding balls with different particle sizes, the weight ratio of the grinding balls to the powder, and the amount of water can be controlled to obtain the desired particle size of the oxide powder.

According to an embodiment of the disclosure, in the step (1), the dispersant is selected from at least one of hypromellose, sodium carboxymethyl cellulose or triethanolamine. The binder is selected from polyvinyl alcohol and/or polyethylene glycol 4000, that is to say, the binder contains one or both of polyvinyl alcohol and polyethylene glycol 4000. The dispersant can promote the uniform mixing of the components in the powder. The binder is beneficial to the formability of the powder. In some embodiments, the binder is polyvinyl alcohol (PVA) and polyethylene glycol 4000 (PEG4000), and the molar ratio of polyvinyl alcohol and polyethylene glycol 4000 is 1:(1-2). In some embodiments, the molar ratio of polyvinyl alcohol and polyethylene glycol 4000 may be 1:1. In the disclosure, both the dispersant and the binder are commercially available.

According to an embodiment of the disclosure, the dispersant is added in an amount of 0.005-0.5 wt %. In some embodiments, the added amount may be 0.01-0.1 wt % based on the total weight of the powders of components in the composition.

According to an embodiment of the disclosure, the binder is added in an amount of 0.5-5 wt %. In some embodiments, the added amount may be 2-5 wt % based on the total weight of the powders of components in the composition.

According to an embodiment of the disclosure, the solid content of the slurry is 20-60 wt %. In some embodiments, the solid content of the slurry may be 25-55 wt %, to achieve a better abrasive effect.

According to an embodiment of the disclosure, various drying methods can be employed in the step (2), for example, spray drying can be used, to form a spherical powder with strong fluidity. The spherical powder with strong fluidity means that the powder has better sphericity, and is in a compacted state. That is, the powder is dense. In some embodiments, the inlet air temperature for spray drying is 220-280° C., the outlet air temperature is 100-120° C., and the rotational speed for centrifugation is 10-20 rpm.

According to an embodiment of the disclosure, in the step (3), the composite zirconia powder is prepared into a ceramic. The composite zirconia powder can be formed first, and then sintered. The forming can be achieved by dry pressing, isostatic pressing, injection molding, and hot casting forming. The forming can be performed by a press with a tonnage of 180-220 tons using a hydraulic oil pressure of 6-10 MPa. By using different molds, the formed ceramic can have different shapes, for example, it has the shape of a mobile back cover after forming. The sintering can be carried out in air, or the sintering can be implemented two steps, including sintering in air first, and then re-sintering in a reducing atmosphere. In some embodiments, the sintering procedure includes: heating from room temperature to 600° C. over 400 min and holding for 2 hrs, heating from 600° C. to 1150° C. over 300 min and holding for 2 hrs, heating from 1150° C. to 1370-1480° C. over 150 min and holding for 1-2 hrs, then cooling to 900° C. over 150 min, and finally, cooling to room temperature naturally. The sintering procedure may also include: heating from room temperature to 600° C. over 400 min and holding for 2 hrs, heating from 600° C. to 1150° C. over 300 min and holding for 2 hrs, heating from 1150° C. to 1300° C. over 150 min and holding for 2 hrs, heating from 1300° C. to 1380-1480° C. over 50 min and holding for 1-2 hrs, then cooling to 900° C. over 150 min, and finally, cooling to room temperature naturally.

According to an embodiment of the disclosure, the ceramic obtained after sintering is also surface ground, polished, and cut into the final product by laser. Those skilled in the art can understand that after surface grinding, polishing, and cutting, the final product can have a specific shape and high smoothness, and can be used as an electronic product casing or ornament.

A fourth aspect of the disclosure provides a ceramic component, which includes the aforementioned zirconia ceramic.

A fifth aspect of the disclosure provides use of a zirconia ceramic according to the disclosure in the preparation of electronic product casings or ornaments.

Hereinafter, the disclosure will be described in detail by way of examples. In the examples and comparative examples:

Fracture toughness Kw: hardness tester and indentation method (diamond indenter, load 10 kg, test time 15 s).

Hardness Hv: hardness tester and indentation method (diamond indenter, load 10 kg, test time 15 s).

Drop weight impact: drop weight impact tester (manufacturer CKSI, model E602SS). The sample is placed on the platform, hit with a drop hammer of 60 g at a height starting from 5 cm; and if no cracks occur, the height is increased by 5 cm each time, until the sample has cracks visible to the naked eyes. The height value is recorded.

Deformation ratio: 20 ceramic samples are sintered, one having a flatness greater than 0.4 mm is defective, and the percentage of the number of defective samples relative to the 20 samples is the deformation rate. A lower ratio indicates a higher yield of the samples.

SEM image: After the sample is polished, an image at a magnification of 200 times is taken by using the scanning electron microscope (SEM) model JSM-7600F from Japan Electron Optics Laboratory Co., Ltd.

Chromaticity (Lab) test: A colorimeter from Nuosu Electronics-China-color 1101 is used to test the L, a, and b values of the sample and compare them with standard samples of carbon black blackening. L is from 85 to 95, a is from −0.5 to 0.5, and b is from −1 to 1, indicating a white color.

XRD test: The X-ray diffractometer Smartlab (3kW) is used to test the phase type and content.

XRF test: The energy dispersive X-ray fluorescence spectrometer EDX-7000 is used to test the element content of polished samples.

In the examples and comparative examples, the compositions and amounts of the raw materials and samples prepared are shown in Table 1.

### EXAMPLE 1

Raw material: composite powder 200 g, including 2.5 wt % of niobium pentoxide (Nb₂O₅), 2 wt % of alumina (Al₂O₃), and 3 wt % of zirconium silicate (ZrSiO₄), with the rest being a zirconia powder containing 3 mol % of yttrium oxide. The weight ratio of alumina:zirconium silicate was 1:1.5.

The raw materials were ball milled with water in a ball mill jar for 8 hrs, and then sand milled with sodium carboxymethyl cellulose of 0.02 wt % based on the composite powder and water in a sand mill for 10 hrs. Finally, a binder (PEG4000 and PVA at a molar ratio of 1:1) of 4 wt % based on the composite powder was added and stirred for 0.5 hrs, to form a spray slurry, with a solid content of 25 wt %.

The slurry was fed to a spray tower for spray drying (with an inlet air temperature of 250° C., an outlet air temperature of 110° C., and a rotational speed of centrifugation of 15 rpm), to form a spherical powder with strong fluidity for dry pressing. Then the powder was formed by dry pressing (using a press with a tonnage of 200 tons using a hydraulic oil pressure of 8 MPa).

The formed powder was heated from room temperature to 600° C. over 400 min and held for 2 hrs; heated from 600° C. to 1150° C. over 300 min and held for 2 hrs; heated from 1150° C. to 1410° C. over 150 min and held for 2 hrs; then cooled to 900° C. over 150 min; and finally, cooled to room temperature naturally to finish the sintering in air.

The sintered product is surface ground, polished and laser cut to prepare a final sample, having a shape and size of those of a back cover of a mobile phone, that is, 150*75*0.6 mm.

The prepared sample was detected by high energy XRF and XRD. The results are shown in Table 1. The weight ratio of Al:Si is 2.4. The tetragonal zirconia is a solid solution of zirconia formed with yttrium oxide, and niobium oxide.

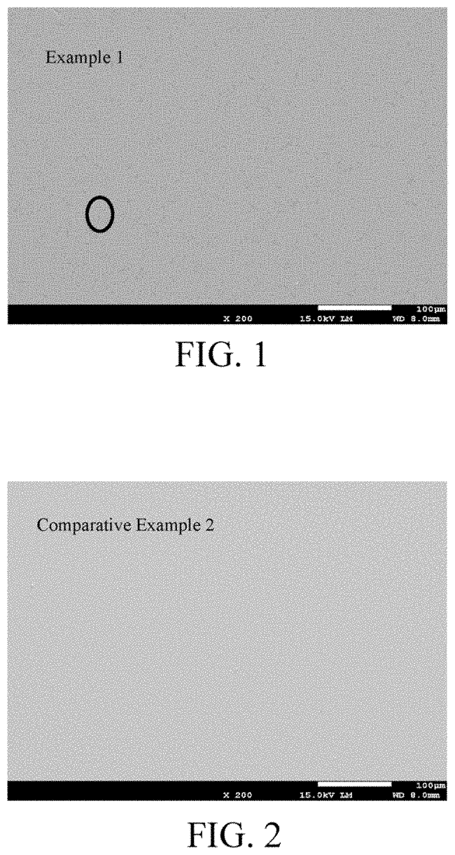

The prepared sample was observed under a scanning electron microscope (SEM). The image is shown in FIG. 1, where the circle contains heterogeneous particles that are an aggregate state of zirconium silicate and aluminum. As can be seen from the figure, after adding alumina and zirconium silicate, the sintered ceramic presents the heterogeneous particles shown in the circle, that is, there is an aggregate state of zirconium silicate and aluminum in the ceramic.

### EXAMPLE 2

Raw material: composite powder 200 g, including 2.5 wt % of niobium pentoxide (Nb₂O₅), 4.5 wt % of alumina (Al₂O₃), and 4.5 wt % of zirconium silicate (ZrSiO₄), with the rest being a zirconia powder containing 2 mol % of yttrium oxide. The weight ratio of alumina:zirconium silicate was 1:1.

The raw materials were ball milled with water in a ball mill jar for 8 hrs, and then sand milled with triethanol amine of 0.01 wt % based on the composite powder and water in a sand mill for 10 hrs. Finally, a binder (PEG4000 and PVA at a molar ratio of 1:1) of 5 wt % based on the composite powder was added and stirred for 0.5 hrs, to form a spray slurry, with a solid content of 55 wt %.

The slurry was fed to a spray tower for spray drying (with an inlet air temperature of 250° C., an outlet air temperature of 110° C., and a rotational speed of centrifugation of 15 rpm), to form a spherical powder with strong fluidity for dry pressing. Then the powder was formed by dry pressing (using a press with a tonnage of 200 tons using a hydraulic oil pressure of 8 MPa).

The formed powder was heated from room temperature to 600° C. over 400 min and held for 2 hrs; heated from 600° C. to 1150° C. over 300 min and held for 2 hrs; heated from 1150° C. to 1370° C. over 150 min and held for 2 hrs; then cooled to 900° C. over 150 min; and finally, cooled to room temperature naturally to finish the sintering in air.

The sintered product is surface ground, polished and laser cut to prepare a final sample, having a shape and size of those of a back cover of a mobile phone, that is, 150*75*0.6 mm.

The prepared sample was detected by high energy XRF and XRD. The results are shown in Table 1, The weight ratio of Al:Si is 3.6. The tetragonal zirconia is a solid solution of zirconia formed with yttrium oxide, and niobium oxide.

The sample was observed under a scanning electron microscope (SEM). An image similar to that shown in FIG. 1 is obtained, indicating heterogeneous particles present in the ceramic, that is, there is an aggregate state of zirconium silicate and aluminum in the ceramic.

### EXAMPLE 3

Raw material: composite powder 200 g, including 2.5 wt % of niobium pentoxide (Nb₂O₅), 1 wt % of alumina (Al₂O₃), and 1.5 wt % of zirconium silicate (ZrSiO₄), with the rest being a zirconia powder containing 4 mol % of yttrium oxide. The weight ratio of alumina:zirconium silicate was 1:1.5.

The raw materials were ball milled with water in a ball mill jar for 8 hrs, and then sand milled with sodium hydroxymethyl cellulose of 0.1 wt % based on the composite powder and water in a sand mill for 10 hrs. Finally, a binder (PEG4000 and PVA at a molar ratio of 1:1) of 2 wt % based on the composite powder was added and stirred for 0.5 hrs, to form a spray slurry, with a solid content of 40 wt %.

The slurry was fed to a spray tower for spray drying (with an inlet air temperature of 250° C., an outlet air temperature of 110° C., and a rotational speed of centrifugation of 15 rpm), to form a spherical powder with strong fluidity for dry pressing. Then the powder was formed by dry pressing (using a press with a tonnage of 200 tons using a hydraulic oil pressure of 8 MPa).

The formed powder was heated from room temperature to 600° C. over 400 min and held for 2 hrs; heated from 600° C. to 1150° C. over 300 min and held for 2 hrs; heated from 1150° C. to 1370° C. over 150 min and held for 2 hrs; then cooled to 900° C. over 150 min; and finally, cooled to room temperature naturally to finish the sintering in air.

The sintered product is surface ground, polished and laser cut to prepare a final sample, having a shape and size of those of a back cover of a mobile phone, that is, 150*75*0.6 mm.

The prepared sample was detected by high energy XRF and XRD. The results are shown in Table 1, The weight ratio of Al:Si is 2.3. The tetragonal zirconia is a solid solution of zirconia formed with yttrium oxide, and niobium oxide.

The prepared sample was observed under a scanning electron microscope (SEM). An image similar to that shown in FIG. 1 is obtained, indicating heterogeneous particles present in the ceramic, that is, there is an aggregate state of zirconium silicate and aluminum in the ceramic.

### EXAMPLE 4

Raw material: composite powder 200 g, 2 wt % of niobium pentoxide (Nb₂O₅), 2 wt % of alumina (Al₂O₃), and 3 wt % of zirconium silicate (ZrSiO₄), with the rest being a zirconia powder containing 3 mol % of yttrium oxide. The weight ratio of alumina:zirconium silicate was 1:1.5.

The raw materials were ball milled with water in a ball mill jar for 8 hrs, and then sand milled with hypromellose (dispersant) of 0.02 wt % based on the composite powder and water in a sand mill for 10 hrs. Finally, a binder (PEG4000 and PVA at a molar ratio of 1:1) of 4 wt % based on the composite powder was added and stirred for 0.5 hrs, to form a spray slurry, with a solid content of 25 wt %.

The slurry was fed to a spray tower for spray drying (with an inlet air temperature of 250° C., an outlet air temperature of 110° C., and a rotational speed of centrifugation of 15 rpm), to form a spherical powder with strong fluidity for dry pressing. Then the powder was formed by dry pressing (using a press with a tonnage of 200 tons using a hydraulic oil pressure of 8 MPa).

The formed powder was heated from room temperature to 600° C. over 400 min and held for 2 hrs; heated from 600° C. to 1150° C. over 300 min and held for 2 hrs; heated from 1150° C. to 1410° C. over 150 min and held for 2 hrs; then cooled to 900° C. over 150 min; and finally, cooled to room temperature naturally to finish the sintering in air.

The sintered product is surface ground, polished and laser cut to prepare a final sample, having a shape and size of those of a back cover of a mobile phone, that is, 150*75*0.6 mm.

The prepared sample was detected by high energy XRF and XRD. The results are shown in Table 1, The weight ratio of Al:Si is 2.4. The tetragonal zirconia is a solid solution of zirconia formed with yttrium oxide, and niobium oxide.

The sample was observed under a scanning electron microscope (SEM). An image similar to that shown in FIG. 1 is obtained, indicating heterogeneous particles present in the ceramic, that is, there is an aggregate state of zirconium silicate and aluminum in the ceramic.

### EXAMPLE 5

Raw material: composite powder 200 g, including 3 wt % of niobium pentoxide (Nb₂O₅), 2 wt % of alumina (Al₂O₃), and 3 wt % of zirconium silicate (ZrSiO₄), with the rest being a zirconia powder containing 3 mol % of yttrium oxide. The weight ratio of alumina:zirconium silicate was 1:1.5.

The raw materials were ball milled with water in a ball mill jar for 8 hrs, and then sand milled with hypromellose (dispersant) of 0.02 wt % based on the composite powder and water in a sand mill for 10 hrs. Finally, a binder (PEG4000 and PVA at a molar ratio of 1:1) of 4 wt % based on the composite powder was added and stirred for 0.5 hrs, to form a spray slurry, with a solid content of 25 wt %.

The slurry was fed to a spray tower for spray drying (with an inlet air temperature of 250° C., an outlet air temperature of 110° C., and a rotational speed of centrifugation of 15 rpm), to form a spherical powder with strong fluidity for dry pressing. Then the powder was formed by dry pressing (using a press with a tonnage of 200 tons using a hydraulic oil pressure of 8 MPa).

The formed powder was heated from room temperature to 600° C. over 400 min and held for 2 hrs; heated from 600° C. to 1150° C. over 300 min and held for 2 hrs; heated from 1150° C. to 1410° C. over 150 min and held for 2 hrs; then cooled to 900° C. over 150 min; and finally, cooled to room temperature naturally to finish the sintering in air.

The sintered product is surface ground, polished and laser cut to prepare a final sample, having a shape and size of those of a back cover of a mobile phone, that is, 150*75*0.6 mm.

The prepared sample was detected by high energy XRF and XRD. The results are shown in Table 1, The weight ratio of Al:Si is 2.4. The tetragonal zirconia is a solid solution of zirconia formed with yttrium oxide, and niobium oxide.

The sample was observed under a scanning electron microscope (SEM). An image similar to that shown in FIG. 1 is obtained, indicating heterogeneous particles present in the ceramic, that is, there is an aggregate state of zirconium silicate and aluminum in the ceramic.

### EXAMPLE 6

Raw material: composite powder 200 g, including 2.5 wt % of niobium pentoxide (Nb₂O₅), 3 wt % of alumina (Al₂O₃), 3 wt % of zirconium silicate (ZrSiO₄), with the rest being a zirconia powder containing 3 mol % of yttrium oxide. The weight ratio of alumina:zirconium silicate was 1:1.

The raw materials were ball milled with water in a ball mill jar for 8 hrs, and then sand milled with hypromellose (dispersant) of 0.02 wt % based on the composite powder and water in a sand mill for 10 hrs. Finally, a binder (PEG4000 and PVA at a molar ratio of 1:1) of 4 wt % based on the composite powder was added and stirred for 0.5 hrs, to form a spray slurry, with a solid content of 25 wt %.

The slurry was fed to a spray tower for spray drying (with an inlet air temperature of 250° C., an outlet air temperature of 110° C., and a rotational speed of centrifugation of 15 rpm), to form a spherical powder with strong fluidity for dry pressing. Then the powder was formed by dry pressing (using a press with a tonnage of 200 tons using a hydraulic oil pressure of 8 MPa).

The formed powder was heated from room temperature to 600° C. over 400 min and held for 2 hrs; heated from 600° C. to 1150° C. over 300 min and held for 2 hrs; heated from 1150° C. to 1410° C. over 150 min and held for 2 hrs; then cooled to 900° C. over 150 min; and finally, cooled to room temperature naturally to finish the sintering in air.

The sintered product is surface ground, polished and laser cut to prepare a final sample, having a shape and size of those of a back cover of a mobile phone, that is, 150*75*0.6 mm.

The prepared sample was detected by high energy XRF and XRD. The results are shown in Table 1, The weight ratio of Al:Si is 3.5. The tetragonal zirconia is a solid solution of zirconia formed with yttrium oxide, and niobium oxide.

The sample was observed under a scanning electron microscope (SEM). An image similar to that shown in FIG. 1 is obtained, indicating heterogeneous particles present in the ceramic, that is, there is an aggregate state of zirconium silicate and aluminum in the ceramic.

### EXAMPLE 7

Raw material: composite powder 200 g, including 2.5 wt % of niobium pentoxide (Nb₂O₅), 2 wt % of alumina (Al₂O₃), and 4.5 wt % of zirconium silicate (ZrSiO₄), with the rest being a zirconia powder containing 3 mol % of yttrium oxide. The weight ratio of alumina:zirconium silicate was 1:2.25.

The raw materials were ball milled with water in a ball mill jar for 8 hrs, and then sand milled with hypromellose (dispersant) of 0.02 wt % based on the composite powder and water in a sand mill for 10 hrs. Finally, a binder (PEG4000 and PVA at a molar ratio of 1:1) of 4 wt % based on the composite powder was added and stirred for 0.5 hrs, to form a spray slurry, with a solid content of 25 wt %.

The slurry was fed to a spray tower for spray drying (with an inlet air temperature of 250° C., an outlet air temperature of 110° C., and a rotational speed of centrifugation of 15 rpm), to form a spherical powder with strong fluidity for dry pressing. Then the powder was formed by dry pressing (using a press with a tonnage of 200 tons using a hydraulic oil pressure of 8 MPa).

The formed powder was heated from room temperature to 600° C. over 400 min and held for 2 hrs; heated from 600° C. to 1150° C. over 300 min and held for 2 hrs; heated from 1150° C. to 1410° C. over 150 min and held for 2 hrs; then cooled to 900° C. over 150 min; and finally, cooled to room temperature naturally to finish the sintering in air.

The sintered product was surface ground, polished and laser cut to prepare a final sample, having a shape and size of those of a back cover of a mobile phone, that is, 150*75*0.6 mm.

The prepared sample was detected by high energy XRF and XRD. The results are shown in Table 1, The weight ratio of Al:Si is 1.6. The tetragonal zirconia is a solid solution of zirconia formed with yttrium oxide, and niobium oxide.

The prepared sample was observed under a scanning electron microscope (SEM). An image similar to that shown in FIG. 1 is obtained, indicating heterogeneous particles present in the ceramic, that is, there is an aggregate state of zirconium silicate and aluminum in the ceramic.

### EXAMPLE 8

Raw material: composite powder 200 g, including 2.5 wt % of tantalum pentoxide (Ta₂O₅), 2 wt % of alumina (Al₂O₃), and 3 wt % of zirconium silicate (ZrSiO₄), with the rest being a zirconia powder containing 3 mol % of yttrium oxide. The weight ratio of alumina:zirconium silicate was 1:1.5.

The raw materials were ball milled with water in a ball mill jar for 8 hrs, and then sand milled with sodium carboxymethyl cellulose of 0.02 wt % based on the composite powder and water in a sand mill for 10 hrs. Finally, a binder (PEG4000 and PVA at a molar ratio of 1:1) of 4 wt % based on the composite powder was added and stirred for 0.5 hrs, to form a spray slurry, with a solid content of 25 wt %.

The slurry was fed to a spray tower for spray drying (with an inlet air temperature of 250° C., an outlet air temperature of 110° C., and a rotational speed of centrifugation of 15 rpm), to form a spherical powder with strong fluidity for dry pressing. Then the powder was formed by dry pressing (using a press with a tonnage of 200 tons using a hydraulic oil pressure of 8 MPa).

The formed powder was heated from room temperature to 600° C. over 400 min and held for 2 hrs; heated from 600° C. to 1150° C. over 300 min and held for 2 hrs; heated from 1150° C. to 1410° C. over 150 min and held for 2 hrs; then cooled to 900° C. over 150 min; and finally, cooled to room temperature naturally to finish the sintering in air.

The sintered product is surface ground, polished and laser cut to prepare a final sample, having a shape and size of those of a back cover of a mobile phone, that is, 150*75*0.6 mm.

The prepared sample was detected by high energy XRF and XRD. The results are shown in Table 1, The weight ratio of Al:Si is 2.5. The tetragonal zirconia is a solid solution of zirconia formed with yttrium oxide, and tantalum oxide.

The sample was observed under a scanning electron microscope (SEM). An image similar to that shown in FIG. 1 is obtained, indicating heterogeneous particles present in the ceramic, that is, there is an aggregate state of zirconium silicate and aluminum in the ceramic.

### EXAMPLE 9

Raw material: composite powder 200 g, including 2.5 wt % of niobium pentoxide, 4 wt % of alumina, and 6 wt % of zirconium silicate, with the rest being a zirconia powder containing 3 mol % of yttrium oxide. The weight ratio of alumina:zirconium silicate was 1:1.5.

The raw materials were ball milled with water in a ball mill jar for 8 hrs, and then sand milled with sodium carboxymethyl cellulose of 0.02 wt % based on the composite powder and water in a sand mill for 10 hrs. Finally, a binder (PEG4000 and PVA at a molar ratio of 1:1) of 4 wt % based on the composite powder was added and stirred for 0.5 hrs, to form a spray slurry, with a solid content of 25 wt %.

The slurry was fed to a spray tower for spray drying (with an inlet air temperature of 250° C., an outlet air temperature of 110° C., and a rotational speed of centrifugation of 15 rpm), to form a spherical powder with strong fluidity for dry pressing. Then the powder was formed by dry pressing (using a press with a tonnage of 200 tons using a hydraulic oil pressure of 8 MPa).

The formed powder was heated from room temperature to 600° C. over 400 min and held for 2 hrs; heated from 600° C. to 1150° C. over 300 min and held for 2 hrs; heated from 1150° C. to 1410° C. over 150 min and held for 2 hrs; then cooled to 900° C. over 150 min; and finally, cooled to room temperature naturally to finish the sintering in air.

The sintered product was surface ground, polished and laser cut to prepare a final sample, having a shape and size of those of a back cover of a mobile phone, that is, 150*75*0.6 mm.

The prepared sample was detected by high energy XRF and XRD. The results are shown in Table 1, The weight ratio of Al:Si is 2.3. The tetragonal zirconia is a solid solution of zirconia formed with yttrium oxide, and niobium oxide.

The prepared sample was observed under a scanning electron microscope (SEM). An image similar to that shown in FIG. 1 is obtained, indicating heterogeneous particles present in the ceramic, that is, there is an aggregate state of zirconium silicate and aluminum in the ceramic.

### EXAMPLE 10

Raw material: composite powder 200 g, including 2.5 wt % of niobium pentoxide, 3 wt % of alumina, 2 wt % of zirconium silicate, with the rest being a zirconia powder containing 3 mol % of yttrium oxide. The weight ratio of alumina:zirconium silicate was 1:0.67.

The raw materials were ball milled with water in a ball mill jar for 8 hrs, and then sand milled with sodium carboxymethyl cellulose of 0.02 wt % based on the composite powder and water in a sand mill for 10 hrs. Finally, a binder (PEG4000 and PVA at a molar ratio of 1:1) of 4 wt % based on the composite powder was added and stirred for 0.5 hrs, to form a spray slurry, with a solid content of 25 wt %.

The slurry was fed to a spray tower for spray drying (with an inlet air temperature of 250° C., an outlet air temperature of 110° C., and a rotational speed of centrifugation of 15 rpm), to form a spherical powder with strong fluidity for dry pressing. Then the powder was formed by dry pressing (using a press with a tonnage of 200 tons using a hydraulic oil pressure of 8 MPa).

The formed powder was heated from room temperature to 600° C. over 400 min and held for 2 hrs; heated from 600° C. to 1150° C. over 300 min and held for 2 hrs; heated from 1150° C. to 1410° C. over 150 min and held for 2 hrs; then cooled to 900° C. over 150 min; and finally, cooled to room temperature naturally to finish the sintering in air.

The sintered product was surface ground, polished and laser cut to prepare a final sample, having a shape and size of those of a back cover of a mobile phone, that is, 150*75*0.6 mm.

The prepared sample was detected by high energy XRF and XRD. The results are shown in Table 1, The weight ratio of Al:Si is 5.4. The tetragonal zirconia is a solid solution of zirconia formed with yttrium oxide, and niobium oxide.

The prepared sample was observed under a scanning electron microscope (SEM). An image similar to that shown in FIG. 1 is obtained, indicating heterogeneous particles present in the ceramic, that is, there is an aggregate state of zirconium silicate and aluminum in the ceramic.

### EXAMPLE 11

Raw material: composite powder 200 g, including 2.5 wt % of niobium pentoxide, 1 wt % of alumina, 6 wt % of zirconium silicate, with the rest being a zirconia powder containing 3 mol % of yttrium oxide. The weight ratio of alumina:zirconium silicate was 1:6.

The raw materials were ball milled with water in a ball mill jar for 8 hrs, and then sand milled with sodium carboxymethyl cellulose of 0.02 wt % based on the composite powder and water in a sand mill for 10 hrs. Finally, a binder (PEG4000 and PVA at a molar ratio of 1:1) of 4 wt % based on the composite powder was added and stirred for 0.5 hrs, to form a spray slurry, with a solid content of 25 wt %.

The slurry was fed to a spray tower for spray drying (with an inlet air temperature of 250° C., an outlet air temperature of 110° C., and a rotational speed of centrifugation of 15 rpm), to form a spherical powder with strong fluidity for dry pressing. Then the powder was formed by dry pressing (using a press with a tonnage of 200 tons using a hydraulic oil pressure of 8 MPa).

The formed powder was heated from room temperature to 600° C. over 400 min and held for 2 hrs; heated from 600° C. to 1150° C. over 300 min and held for 2 hrs; heated from 1150° C. to 1410° C. over 150 min and held for 2 hrs; then cooled to 900° C. over 150 min; and finally, cooled to room temperature naturally to finish the sintering in air.

The sintered product was surface ground, polished and laser cut to prepare a final sample, having a shape and size of those of a back cover of a mobile phone, that is, 150*75*0.6 mm.

The prepared sample was detected by high energy XRF and XRD. The results are shown in Table 1, The weight ratio of Al:Si is 0.6. The tetragonal zirconia is a solid solution of zirconia formed with yttrium oxide, and niobium oxide.

The prepared sample was observed under a scanning electron microscope (SEM). An image similar to that shown in FIG. 1 is obtained, indicating heterogeneous particles present in the ceramic, that is, there is an aggregate state of zirconium silicate and aluminum in the ceramic.

### EXAMPLE 12

Raw material: composite powder 200 g, including 4 wt % of niobium pentoxide, 2 wt % of alumina, and 3 wt % of zirconium silicate, with the rest being a zirconia powder containing 3 mol % of yttrium oxide. The weight ratio of alumina:zirconium silicate was 1:1.5.

The raw materials were ball milled with water in a ball mill jar for 8 hrs, and then sand milled with sodium carboxymethyl cellulose of 0.02 wt % based on the composite powder and water in a sand mill for 10 hrs. Finally, a binder (PEG4000 and PVA at a molar ratio of 1:1) of 4 wt % based on the composite powder was added and stirred for 0.5 hrs, to form a spray slurry, with a solid content of 25 wt %.

The slurry was fed to a spray tower for spray drying (with an inlet air temperature of 250° C., an outlet air temperature of 110° C., and a rotational speed of centrifugation of 15 rpm), to form a spherical powder with strong fluidity for dry pressing. Then the powder was formed by dry pressing (using a press with a tonnage of 200 tons using a hydraulic oil pressure of 8 MPa).

The formed powder was heated from room temperature to 600° C. over 400 min and held for 2 hrs; heated from 600° C. to 1150° C. over 300 min and held for 2 hrs; heated from 1150° C. to 1410° C. over 150 min and held for 2 hrs; then cooled to 900° C. over 150 min; and finally, cooled to room temperature naturally to finish the sintering in air.

The sintered product was surface ground, polished and laser cut to prepare a final sample, having a shape and size of those of a back cover of a mobile phone, that is, 150*75*0.6 mm.

The prepared sample was detected by high energy XRF and XRD. The results are shown in Table 1, The weight ratio of Al:Si is 2.3. The tetragonal zirconia is a solid solution of zirconia formed with yttrium oxide, and niobium oxide.

The prepared sample was observed under a scanning electron microscope (SEM). An image similar to that shown in FIG. 1 is obtained, indicating heterogeneous particles present in the ceramic, that is, there is an aggregate state of zirconium silicate and aluminum in the ceramic.

### EXAMPLE 13

Raw material: composite powder 200 g, including 2.5 wt % of niobium pentoxide, 6 wt % of alumina, 6 wt % of zirconium silicate, with the rest being a zirconia powder containing 3 mol % of yttrium oxide. The weight ratio of alumina:zirconium silicate was 1:1.

The raw materials were ball milled with water in a ball mill jar for 8 hrs, and then sand milled with sodium carboxymethyl cellulose of 0.02 wt % based on the composite powder and water in a sand mill for 10 hrs. Finally, a binder (PEG4000 and PVA at a molar ratio of 1:1) of 4 wt % based on the composite powder was added and stirred for 0.5 hrs, to form a spray slurry, with a solid content of 25 wt %.

The slurry was fed to a spray tower for spray drying (with an inlet air temperature of 250° C., an outlet air temperature of 110° C., and a rotational speed of centrifugation of 15 rpm), to form a spherical powder with strong fluidity for dry pressing. Then the powder was formed by dry pressing (using a press with a tonnage of 200 tons using a hydraulic oil pressure of 8 MPa).

The formed powder was heated from room temperature to 600° C. over 400 min and held for 2 hrs; heated from 600° C. to 1150° C. over 300 min and held for 2 hrs; heated from 1150° C. to 1410° C. over 150 min and held for 2 hrs; then cooled to 900° C. over 150 min; and finally, cooled to room temperature naturally to finish the sintering in air.

The sintered product is surface ground, polished and laser cut to prepare a final sample, having a shape and size of those of a back cover of a mobile phone, that is, 150*75*0.6 mm.

The prepared sample was detected by high energy XRF and XRD. The results are shown in Table 1, The weight ratio of Al:Si is 3.5. The tetragonal zirconia is a solid solution of zirconia formed with yttrium oxide, and niobium oxide.

The prepared sample was observed under a scanning electron microscope (SEM). An image similar to that shown in FIG. 1 is obtained, indicating heterogeneous particles present in the ceramic, that is, there is an aggregate state of zirconium silicate and aluminum in the ceramic.

### Comparative Embodiment 1

Raw material: composite powder 200 g, including 0.25 wt % of alumina (Al₂O₃), with the rest being a zirconia powder containing 3 mol % of yttrium oxide.

The raw materials were ball milled with water in a ball mill jar for 8 hrs, and then sand milled with hypromellose of 0.02 wt % based on the composite powder and water in a sand mill for 10 hrs. Finally, a binder (PEG4000 and PVA at a molar ratio of 1:1) of 4 wt % based on the composite powder was added and stirred for 0.5 hrs, to form a spray slurry.

The slurry was fed to a spray tower for spray drying (with an inlet air temperature of 250° C., an outlet air temperature of 110° C., and a rotational speed of centrifugation of 15 rpm), to form a spherical powder with strong fluidity for dry pressing. Then the powder was formed by dry pressing (using a press with a tonnage of 200 tons using a hydraulic oil pressure of 8 MPa).

The formed powder was heated from room temperature to 600° C. over 400 min and held for 2 hrs; heated from 600° C. to 1150° C. over 300 min and held for 2 hrs; heated from 1150° C. to 1410° C. over 150 min and held for 2 hrs; then cooled to 900° C. over 150 min; and finally, cooled to room temperature naturally to finish the sintering in air.

The sintered product was surface ground, polished and laser cut to prepare a final sample, having a shape and size of those of a back cover of a mobile phone, that is, 150*75*0.6 mm.

The prepared sample was detected by high energy XRF and XRD. The results are shown in Table 1. The tetragonal zirconia is a solid solution of zirconia formed with yttrium oxide.

### Comparative Embodiment 2

Raw material: composite powder 200 g, including 2.5 wt % of niobium pentoxide, and 0.25 wt % of alumina (Al₂O₃), with the rest being a zirconia powder containing 3 mol % of yttrium oxide.

The raw materials were ball milled with water in a ball mill jar for 8 hrs, and then sand milled with hypromellose of 0.02 wt % based on the composite powder and water in a sand mill for 10 hrs. Finally, a binder (PEG4000 and PVA at a molar ratio of 1:1) of 4 wt % based on the composite powder was added and stirred for 0.5 hrs, to form a spray slurry.

The slurry was fed to a spray tower for spray drying (with an inlet air temperature of 250° C., an outlet air temperature of 110° C., and a rotational speed of centrifugation of 15 rpm), to form a spherical powder with strong fluidity for dry pressing. Then the powder was formed by dry pressing (using a press with a tonnage of 200 tons using a hydraulic oil pressure of 8 MPa).

The formed powder was heated from room temperature to 600° C. over 400 min and held for 2 hrs; heated from 600° C. to 1150° C. over 300 min and held for 2 hrs; heated from 1150° C. to 1410° C. over 150 min and held for 2 hrs; then cooled to 900° C. over 150 min; and finally, cooled to room temperature naturally to finish the sintering in air.

The sintered product was surface ground, polished and laser cut to prepare a final sample, having a shape and size of those of a back cover of a mobile phone, that is, 150*75*0.6 mm.

The prepared sample was detected by high energy XRF and XRD. The results are shown in Table 1. The tetragonal zirconia is a solid solution of zirconia formed with yttrium oxide, and niobium oxide.

The sample was observed under a scanning electron microscope (SEM). As shown in FIG. 2, there are no heterogeneous particles.

### Comparative Example 3

The method in Example 1 was adopted, except that no zirconium silicate was used in the preparation of zirconia ceramics.

The sintered product is surface ground, polished and laser cut to prepare a final sample, having a shape and size of those of a back cover of a mobile phone, that is, 150*75*0.6 mm.

The prepared sample was detected by high energy XRF and XRD. The results are shown in Table 1. The tetragonal zirconia is a solid solution of zirconia formed with yttrium oxide, and niobium oxide.

### Comparative Example 4

The method in Example 1 was adopted, except that no alumina was used in the preparation of zirconia ceramics.

The sintered product is surface ground, polished and laser cut to prepare a final sample, having a shape and size of those of a back cover of a mobile phone, that is, 150*75*0.6 mm.

The prepared sample was detected by high energy XRF and XRD. The results are shown in Table 1. The tetragonal zirconia is a solid solution of zirconia formed with yttrium oxide, and niobium oxide.

TABLE 1

| Example 1 | Composition, wt % | | | | | |
|---|---|---|---|---|---|---|
| Feed | ZrO₂ containing 3 mol % | | Al₂O₃ | ZrSiO₄ | Nb₂O₅ | Ta₂O₅ |
| | Y₂O₃ | | | | | |
| | 92.5 | | 2 | 3 | 2.5 | |
| Elements contained | Zr | Y | Al | Si | Nb | |
| in ceramic | 66.1 | 3.8 | 1.1 | 0.46 | 1.7 | |
| Phases of ceramic | Tetragonal | ZrSiO₄ | Al₂O₃ | | | |
| | ZrO₂ | | | | | |
| | 94.3 | 3.1 | 1.9 | | | |
| Embodiment 2 | Composition, wt % | | | | | |
| Feed | ZrO₂ containing 2 mol % | | Al₂O₃ | ZrSiO₄ | Nb₂O₅ | Ta₂O₅ |
| | Y₂O₃ | | | | | |
| | 88.5 | | 4.5 | 4.5 | 2.5 | |
| Elements contained | Zr | Y | Al | Si | Nb | |
| in ceramic | 64.9 | 2.52 | 2.35 | 0.65 | 1.7 | |
| Phases of ceramic | Tetragonal | ZrSiO₄ | Al₂O₃ | | | |
| | ZrO₂ | | | | | |
| | 89.5 | 4.3 | 4.2 | | | |
| Example 3 | Composition, wt % | | | | | |
| Feed | ZrO₂ containing 4 mol % | | Al₂O₃ | ZrSiO₄ | Nb₂O₅ | Ta₂O₅ |
| | Y₂O₃ | | | | | |
| | 95 | | 1 | 1.5 | 2.5 | |
| Elements contained | Zr | Y | Al | Si | Nb | |
| in ceramic | 66.1 | 5.1 | 0.53 | 0.23 | 1.7 | |
| Phases of ceramic | Tetragonal | ZrSiO₄ | Al₂O₃ | | | |
| | ZrO₂ | | | | | |
| | 96.6 | 1.45 | 0.92 | | | |
| Example 4 | Composition, wt % | | | | | |
| Feed | ZrO₂ containing 3 mol % | | Al₂O₃ | ZrSiO₄ | Nb₂O₅ | Ta₂O₅ |
| | Y₂O₃ | | | | | |
| | 94 | | 2 | 3 | 1 | |
| Elements contained | Zr | Y | Al | Si | Nb | |
| in ceramic | 67.1 | 3.9 | 1.11 | 0.42 | 0.65 | |
| Phases of ceramic | Tetragonal | ZrSiO₄ | Al₂O₃ | | | |
| | ZrO₂ | | | | | |
| | 94.4 | 2.9 | 1.9 | | | |
| Example 5 | Composition, wt % | | | | | |
| Feed | ZrO₂ containing 3 mol % | | Al₂O₃ | ZrSiO₄ | Nb₂O₅ | Ta₂O₅ |
| | Y₂O₃ | | | | | |
| | 92 | | 2 | 3 | 3 | |
| Elements contained | Zr | Y | Al | Si | Nb | |
| in ceramic | 65.5 | 3.85 | 1.1 | 0.46 | 2.05 | |
| Phases of ceramic | Tetragonal | ZrSiO₄ | Al₂O₃ | | | |
| | ZrO₂ | | | | | |
| | 94.2 | 3.1 | 1.9 | | | |
| Example 6 | Composition, wt % | | | | | |
| Feed | ZrO₂ containing 3 mol % | | Al₂O₃ | ZrSiO₄ | Nb₂O₅ | Ta₂O₅ |
| | Y₂O₃ | | | | | |
| | 91.5 | | 3 | 3 | 2.5 | |
| Elements contained | Zr | Y | Al | Si | Nb | |
| in ceramic | 65.2 | 3.84 | 1.6 | 0.456 | 1.7 | |
| Phases of ceramic | Tetragonal | ZrSiO₄ | Al₂O₃ | | | |
| | ZrO₂ | | | | | |
| | 92.7 | 3.1 | 2.9 | | | |
| Example 7 | Composition, wt % | | | | | |
| Feed | ZrO₂ containing 3 mol % | | Al₂O₃ | ZrSiO₄ | Nb₂O₅ | Ta₂O₅ |
| | Y₂O₃ | | | | | |
| | 91 | | 2 | 4.5 | 2.5 | |
| Elements contained | Zr | Y | Al | Si | Nb | |
| in ceramic | 65.6 | 3.87 | 1.1 | 0.69 | 1.7 | |
| Phases of ceramic | Tetragonal | ZrSiO₄ | Al₂O₃ | | | |
| | ZrO₂ | | | | | |
| | 92.9 | 4.35 | 1.9 | | | |
| Example 8 | Composition, wt % | | | | | |
| Feed | ZrO₂ containing 3 mol % | | Al₂O₃ | ZrSiO₄ | Nb₂O₅ | Ta₂O₅ |
| | Y₂O₃ | | | | | |
| | 92.5 | | 2 | 3 | | 2.5 |
| Elements contained | Zr | Y | Al | Si | | Ta |
| in ceramic | 66.1 | 3.9 | 1.12 | 0.45 | | 2 |
| Phases of ceramic | Tetragonal | ZrSiO₄ | Al₂O₃ | | | |
| | ZrO₂ | | | | | |
| | 94.5 | 3.05 | 1.86 | | | |
| Example 9 | Composition, wt % | | | | | |
| Feed | ZrO₂ containing 3 mol % | | Al₂O₃ | ZrSiO₄ | Nb₂O₅ | Ta₂O₅ |
| | Y₂O₃ | | | | | |
| | 87.5 | | 4 | 6 | 2.5 | |
| Elements contained | Zr | Y | Al | Si | Nb | |
| in ceramic | 63.6 | 3.75 | 2.08 | 0.89 | 1.65 | |
| Phases of ceramic | Tetragonal | ZrSiO₄ | Al₂O₃ | | | |
| | ZrO₂ | | | | | |
| | 88.5 | 6.1 | 3.9 | | | |
| Example 10 | Composition, wt % | | | | | |
| Feed | ZrO₂ containing 3 mol % | | Al₂O₃ | ZrSiO₄ | Nb₂O₅ | Ta₂O₅ |
| | Y₂O₃ | | | | | |
| | 92.5 | | 3 | 2 | 2.5 | |
| Elements contained | Zr | Y | Al | Si | Nb | |
| in ceramic | 65.3 | 3.86 | 1.57 | 0.29 | 1.69 | |
| Phases of ceramic | Tetragonal | ZrSiO₄ | Al₂O₃ | | | |
| | ZrO₂ | | | | | |
| | 94.5 | 2.1 | 2.89 | | | |
| Example 11 | Composition, wt % | | | | | |
| Feed | ZrO₂ containing 3 mol % | | Al₂O₃ | ZrSiO₄ | Nb₂O₅ | Ta₂O₅ |
| | Y₂O₃ | | | | | |
| | 90.5 | | 1 | 6 | 2.5 | |
| Elements contained | Zr | Y | Al | Si | Nb | |
| in ceramic | 65.9 | 3.85 | 0.53 | 0.9 | 1.7 | |
| Phases of ceramic | Tetragonal | ZrSiO₄ | Al₂O₃ | | | |
| | ZrO₂ | | | | | |
| | 92.5 | 6.1 | 0.9 | | | |
| Example 12 | Composition, wt % | | | | | |
| Feed | ZrO₂ containing 3 mol % | | Al₂O₃ | ZrSiO₄ | Nb₂O₅ | Ta₂O₅ |
| | Y₂O₃ | | | | | |
| | 91 | | 2 | 3 | 4 | |
| Elements contained | Zr | Y | Al | Si | Nb | |
| in ceramic | 64.8 | 3.82 | 1.03 | 0.45 | 2.7 | |
| Phases of ceramic | Tetragonal | ZrSiO₄ | Al₂O₃ | | | |
| | ZrO₂ | | | | | |
| | 94.2 | 3.1 | 1.9 | | | |
| Example 13 | Composition, wt % | | | | | |
| Feed | ZrO₂ containing 3 mol % | | Al₂O₃ | ZrSiO₄ | Nb₂O₅ | Ta₂O₅ |
| | Y₂O₃ | | | | | |
| | 85.5 | | 6 | 6 | 2.5 | |
| Elements contained | Zr | Y | Al | Si | Nb | |
| in ceramic | 62.6 | 3.65 | 3.15 | 0.9 | 1.69 | |
| Phases of ceramic | Tetragonal | ZrSiO₄ | Al₂O₃ | | | |
| | ZrO₂ | | | | | |
| | 87.5 | 6.05 | 5.9 | | | |
| Comparative | Composition, wt % | | | | | |
| Example 1 | | | | | | |
| Feed | ZrO₂ containing 3 mol % | | Al₂O₃ | | | |
| | Y₂O₃ | | | | | |
| | 99.75 | | 0.25 | | | |
| Elements contained | Zr | Y | Al | | | |
| in ceramic | 69.9 | 4.13 | 0.13 | | | |
| Phases of ceramic | Tetragonal | | Al₂O₃ | | | |
| | ZrO₂ | | | | | |
| | 99.4 | | 0.24 | | | |
| Comparative | Composition, wt % | | | | | |
| Example 2 | | | | | | |
| Feed | ZrO₂ containing 3 mol % | | Al₂O₃ | | Nb₂O₅ | |
| | Y₂O₃ | | | | | |
| | 97.25 | | 0.25 | | 2.5 | |
| Elements contained | Zr | Y | Al | | Nb | |
| in ceramic | 67.8 | 4.01 | 0.13 | | 1.7 | |
| Phases of ceramic | Tetragonal | | Al₂O₃ | | | |
| | ZrO₂ | | | | | |
| | 98.4 | | 0.23 | | | |
| Comparative | Composition, wt % | | | | | |
| Example 3 | | | | | | |
| Feed | ZrO₂ containing 3 mol % | | Al₂O₃ | ZrSiO₄ | Nb₂O₅ | |
| | Y₂O₃ | | | | | |
| | 95.5 | | 2 | — | 2.5 | |
| Elements contained | Zr | Y | Al | Si | Nb | |
| in ceramic | 66.8 | 3.95 | 1.1 | — | 1.7 | |
| Phases of ceramic | Tetragonal | ZrSiO₄ | Al₂O₃ | | | |
| | ZrO₂ | | | | | |
| | 97.5 | — | 1.9 | | | |
| Comparative | Composition, wt % | | | | | |
| Example 4 | | | | | | |
| Feed | ZrO₂ containing 3 mol % | | Al₂O₃ | ZrSiO₄ | Nb₂O₅ | |
| | Y₂O₃ | | | | | |
| | 94.5 | | | 3 | 2.5 | |
| Elements contained | Zr | Y | Al | Si | Nb | |
| in ceramic | 66.2 | 3.91 | | 0.45 | 1.7 | |
| Phases of ceramic | Tetragonal | ZrSiO₄ | Al₂O₃ | | | |
| | ZrO₂ | | | | | |
| | 96.5 | 2.8 | — | | | |

### Test Example 1

The samples prepared in Examples 1-13 and Comparative Examples 1-4 were subjected to hardness, toughness, deformation rate and drop weight impact tests. The results are shown in Table 2.

TABLE 2

| | | | | Deformation | Average drop | Chromaticity | | |
|---|---|---|---|---|---|---|---|---|
| Item | | Hardness/Hv | Toughness,/MPam^{1/2} | rate/% | height,/cm | L | a | b |
| Example | 1 | 1230 | 11 | 0 | 37 | 91 | 0.3 | −0.7 |
| | 2 | 1210 | 10.9 | 0 | 35 | 92.5 | 0.4 | −0.6 |
| | 3 | 1250 | 12 | 0 | 33 | 90 | 0.25 | −0.65 |
| | 4 | 1255 | 10.9 | 0 | 37 | 91 | 0.25 | −0.65 |
| | 5 | 1215 | 13 | 0 | 32.5 | 90.7 | 0.35 | −0.55 |
| | 6 | 1250 | 11.2 | 0 | 36 | 92 | 0.34 | −0.7 |
| | 7 | 1200 | 11 | 0 | 33 | 92.3 | 0.28 | −0.67 |
| | 8 | 1240 | 10.9 | 0 | 36.5 | 91.6 | 0.4 | −0.5 |
| | 9 | 1210 | 10.6 | 0 | 30.5 | 92.7 | 0.34 | −0.65 |
| | 10 | 1240 | 10.7 | 0 | 28 | 91.2 | 0.25 | −0.66 |
| | 11 | 1185 | 10.3 | 0 | 27.5 | 93.1 | 0.37 | −0.7 |
| | 12 | 1190 | 10.8 | 0 | 31 | 91.4 | 0.39 | −0.8 |
| | 13 | 1195 | 10.8 | 0 | 31.5 | 94.2 | 0.4 | −0.7 |
| Comparative | 1 | 1350 | 5.8 | 0 | 20 | 89 | 0.3 | −0.65 |
| Example | 2 | 1220 | 12 | 0 | 26 | 89.3 | 0.4 | −0.7 |
| | 3 | 1235 | 10 | 25 | 23 | 89.6 | 0.35 | −0.55 |
| | 4 | 1215 | 10 | 0 | 20 | 89.7 | 0.36 | −0.6 |

As can be seen from FIG. 2, compared with the comparative examples, the zirconia ceramic provided in the examples of the disclosure has significantly improved impact resistance and appropriate toughness. as well as suitable hardness. In Examples 10 and 11, the weight ratio of alumina to zirconium silicate is not in the range of 1:(1-5), the impact resistance of the ceramics is poor. The zirconia ceramic in Example 11 has the worst impact resistance in Examples 1-13, and has an average drop height of 27.5 cm, which is still higher than the average drop height in Comparative Examples 1-4, suggesting that the impact resistance of zirconia ceramics according to the disclosure is better than the ceramics in the comparative examples. Moreover, the toughness of the zirconia ceramics according to the disclosure is up to 13 MPa m^{1/2}.

Exemplary embodiments of the disclosure are described above. However, the disclosure is not limited thereto. Various simple variations, including the combination of the technical features in any other suitable manner, may be made to the technical solutions of the disclosure within the scope of the technical idea of the disclosure. Such simple variations and combinations shall also be considered as the content disclosed by the disclosure and shall all fall within the protection scope of the disclosure.

1. A zirconia ceramic, comprising the following elements: 60.5-70.5 wt % of Zr, 2.5-5.45 wt % of Y, 0.05-2.65 wt % of Al, 0.015-1.07 wt % of Si, and 0.34-2.8 wt % of M, wherein M comprises at least one of Nb or Ta; and the zirconia ceramic having a phase composition comprising: tetragonal zirconia, alumina and zirconium silicate, wherein the total content of alumina and zirconium silicate is 0.2-12 wt %, and the content of the tetragonal zirconia is 84-99.3 wt %; and the tetragonal zirconia comprises a solid solution of zirconia formed with yttrium oxide and MₓO_{y}, wherein x satisfies 1≤x≤3, and y satisfies 3≤y≤6.

2. The zirconia ceramic according to claim 1, comprising: 63-68.75 wt % of Zr, 3.35-4.7 wt % of Y, 0.53-1.58 wt % of Al, 0.15-0.92 wt % of Si, and 0.68-2.1 wt % of M.

3. The zirconia ceramic according to claim 1, having a phase composition comprising: tetragonal zirconia, alumina and zirconium silicate, wherein the total content of alumina and zirconium silicate is 2-9 wt %, and the content of the tetragonal zirconia is 88-97 wt %.

4. The zirconia ceramic according to claim 1, wherein the weight ratio of alumina to zirconium silicate is 1: (1-5).

5. (canceled)

6. A composition, comprising: a zirconia-containing component, alumina, zirconium silicate, and MₓO_{y}, wherein based on the total amount of the zirconia-containing component, the zirconia-containing component comprises zirconia and 2-4 mol % of yttrium oxide; and
based on the total weight of the composition, the content of the zirconia-containing component is 84-99.3 wt %, the total content of alumina and zirconium silicate is 0.2-12 wt %, and the content of MₓO_{y} is 0.5-4 wt %.

7. The composition according to claim 6, wherein based on the total weight of the composition, the content of the zirconia-containing component is 88-97 wt %, the total content of alumina and zirconium silicate is 2-9 wt %, and the content of MₓO_{y} is 1-3 wt %.

8. The composition according to claim 6, wherein in the composition, the weight ratio of alumina to zirconium silicate is (1:1)-(1:5).

9. A method for preparing a zirconia ceramic, comprising:
(1) forming a slurry from powders of components in a composition, the composition comprising a zirconia-containing component, alumina, zirconium silicate, and MₓO_{y}, wherein:
based on the total amount of the zirconia-containing component, the zirconia-containing component comprises zirconia and 2-4 mol % of yttrium oxide; and
based on the total weight of the composition, the content of the zirconia-containing component is 84-99.3 wt %, the total content of alumina and zirconium silicate is 0.2-12 wt %, and the content of MₓO_{y} is 0.5-4 wt %;
(2) drying the slurry, to obtain a composite zirconia powder; and
(3) forming and sintering the composite zirconia powder, to obtain a zirconia ceramic.

10. The method according to claim 9, wherein in the step (1), the forming comprises: mixing the powders of components in the composition, a dispersant and a binder, to obtain the slurry.

11. The method according to claim 10, wherein in the step (1), the dispersant is selected from at least one of hypromellose, sodium carboxymethyl cellulose or triethanolamine; and the binder is selected from at least one of polyvinyl alcohol or polyethylene glycol 4000.

12. The method according to claim 11, wherein in the step (1), the dispersant is added in an amount of 0.005-0.5 wt % based on the total weight of the powders of components in the composition.

13. The method according to claim 12, wherein in the step (1), the dispersant is added in an amount of 0.01-0.1 wt % based on the total weight of the powders of components in the composition.

14. The method according to claim 11, wherein in the step (1), the binder is added in an amount of 0.5-5 wt % based on the total weight of the powders of components in the composition.

15. The method according to claim 9, wherein in the step (1), the solid content of the slurry is 20-60 wt %.

16. The method according to claim 9, wherein in the step (3), the sintering is carried out in air.

17. The method according to claim 9, wherein in the step (3), the sintering is carried out in two steps comprising sintering in air first, and then re-sintering in a reducing atmosphere.

18. The method according to claim 9, wherein the sintering procedure comprises: heating from room temperature to 600° C. over 400 min and holding for 2 hrs; heating from 600° C. to 1150° C. over 300 min and holding for 2 hrs; heating from 1150° C. to 1370-1480° C. over 150 min and holding for 1-2 hrs; then cooling to 900° C. over 150 min; and finally, cooling to room temperature naturally.

19. The method according to claim 9, wherein the sintering procedure comprises: heating from room temperature to 600° C. over 400 min and holding for 2 hrs; heating from 600° C. to 1150° C. over 300 min and holding for 2 hrs; heating from 1150° C. to 1300° C. over 150 min and holding for 2 hrs; heating from 1300° C. to 1380-1480° C. over 50 min and holding for 1-2 hrs; then cooling to 900° C. over 150 min; and finally, cooling to room temperature naturally.

20. Use of a zirconia ceramic according to claim 1 in the preparation of electronic product casings or ornaments.
